(19) United States
(12) Patent Application Publication
(10) Pub. No.: US 2002/0052748 A1
(43) Pub. Date: May 2, 2002

(54) Computerized coder-decoder without being restricted by language and method

(76) Inventor: Gustavo Portilla, Pereira (CO)

Correspondence Address: Sanchelima and Associates, P.A., Jesus Sanchelima, Esq., 235 S.W. Le Jeune Rd., Miami, FL, 33134, US

(21) Appl. No.: 10/033,133

(22) Filed: Oct. 22, 2001

Related U.S. Application Data
(63) Continuation-in-part of application No. 09/351,208, filed on Jul. 9, 1999.

(51) Int. Cl. G10L 21/00; G10L 11/00

(52) U.S. Cl. 704/270

(57) ABSTRACT

A computerized system for coding finite numbers of words and symbols in a source language with an indexed database of unique meanings associated with words and symbols in a plurality of other languages. The positioning of the coded words respond to a finite number of grammatical structures in each of the languages characterized by the sequences of the classes of the words or symbols. A user at the source language end has control over the translation method and is allowed or required to eliminate the communication from ambiguities.

### II. TECHNICAL FIELD

The present invention relates to a system for coding information and decoding said information according to the user's lexicon of preference without ambiguities.

### III. BACKGROUND ART

1. Other Related Applications.

The present application is a continuation-in-part of pending (on appeal) of U.S. patent application Ser. No. 09/351,208, filed on Jul. 9, 1999, which is hereby incorporated by reference.

Information is maintained or communicated to others in a manner that the person transmitting it chooses. Each person has a characteristic format for transmitting information whether it is from events he or she observes, or self-generated thoughts. Typically, persons that speak the same language achieve efficient communication links for the transmission and reception of information.

The present invention codifies and encrypts information with a computerized system that includes indexed databases for unambiguous meanings and grammatical structures. Decoding the coded information, whether it is a sentence, a phrase or merely a clause, can selectively result in the same language of the source or other languages. In both instances, there are gains in the efficiency for the transmission and/or storage of the information requiring less bandwidth and/or less storage.

Many attempts to solve the problem of coding information to compress it in order to achieve more efficient transmission requiring less bandwidth have been undertaken in the past. And these methods are typically restricted to the use of one language only. These attempts have limitations that are inherent in the languages being used, and they all include ambiguities. These ambiguities affect the interpretation process and the result received at the other end. The interpretation processes of the prior art are rigid, limited to the information available and with its ambiguities.

The present invention acknowledges that each language has a finite number of meanings (primarily words but other symbols exist also). It is also known that words many times have more than one meaning. And that each language has a finite number of accepted grammatical structures for the creation of links between them for parallel or equivalent structures. The present invention uses cross referenced meanings from each language, supported by a mechanism for eliminating ambiguities and complemented with the specification of the grammatical structure to be used in the source language and correlated with one in the receiving language. The present invention also permits a user to designate a given language as his or her preferred language.

In this invention the information is coded and decoded through the generation of an intermediate and independent code (or universal language that Applicant refers to as Digital Esperanto) with asymmetric characteristics with respect to the other coded languages. The intermediate code has links between each of its meanings and grammatical structures with those of each of the other languages.

A user, at the receiving end, can also tailor the present system to his/her needs or preferences. Therefore, a user may select certain equivalents from the list of meanings to his/her preference over others. It may be that in particular regions, certain meanings in a given language are better understood with certain words than others that could also be officially acceptable for the language. Or, it may be that the lexicon is of a specialized technical level and complex thoughts or meanings are coded.

2. Description of the Related Art.

Applicant believes that the closest references correspond to U.S. Pat. No. 5,075,850 issued to Asahioca et al. and U.S. Pat. No. 5,852,798 issued to Ikuta et al.

The technique disclosed in Asahioka's patent involves the use of a “retrieval flag” and a considerable degree of speculation by guessing that the word translation in the more recent sentence is “preferable”. Col. 5, lines 8-9. Again, there is recognition of a problem with multiple meanings of a word. However, the present invention does not use the technique disclosed in this patent. The patented technique is an educated guess for selecting words with multiple meanings by giving preference to the meaning used in the most recent sentence.

The present invention is considerably more accurate and relies on the use of indexed databases for different languages, information elements (including but not limited to words), classes of information elements and structural arrangements. The invention claimed here centers around the fact that there is a finite number of these elements, classes and arrangements for each language and creates a cross-reference to the other languages. Also, while a word may look the same as written in one language, it may have different meanings and thus they are treated as information elements rather than words. Many times these information elements only have one meaning in a particular location in a sentence structural arrangement or for a given class.

Nothing in the cited references suggests the use of indexed structural arrangements or cross-referencing these arrangements from different languages. In essence, the inventor in the present application is creating a digital Esperanto (universal language) based on a more basic treatment of information elements, regardless of how they are written or represented.

Ikuta et al. failures to provide a solution to the syntax problems and uncertainties of using words with multiple meanings. Ikuta et al.'s summary of the invention, however, merely makes a conclusory statement of the virtues of the patented translation apparatus and machine translation method. There is no recognition of the finite number of elements, classes and structures that can be found in each language. Nor is there a disclosure of the matching of these elements in accordance with their position within a structure to avoid the uncertainties of multiple meanings or syntax problems inherent in all languages.

Even if the variations that could be attributed to Asahioka are tacked on Ikuta's disclosure, the resulting apparatus could not operate to dispel the uncertainties of elements with multiple meanings on syntax problems. The mechanism used by Asahioka depends on the immediate past content of the information being translated for the “approximate” selection of the most correct translation of an element with multiple meanings. The present invention is divorced from this limitation. It does not use the “retrieval flag” mechanism of Asahioka with its inherent uncertainties.

Other patents describing the closest subject matter provide for a number of more or less complicated features that fail to solve the problem in an efficient and economical way. None of these patents suggest the novel features of the present invention.

### IV. SUMMARY OF THE INVENTION

It is one of the main objects of the present invention to provide a system to represent an event or thought as information conveying unique meaning elements by which the meaning elements are free of language limitations and accessible by users of different languages.

It is another object of this present invention to provide such a system that is free from ambiguities and being controlled by the user utilizing the source language to avoid ambiguities.

It is still another object of the present invention to provide such a system that enables users of different languages to transform their words and symbols to intermediate meaning elements accessible from different languages.

It is still another object of this invention to provide a system that is specific and ambiguity-free in the capture of information from the source language, with a resulting code that has no language restrictions and that, when decoded, is flexible enough to admit the preferences of the user of the receiving language without losing the meaning of the information conveyed.

Another object is to provide an asymmetric system for coding and decoding information elements (words and symbols) through procedures that are independent from each other and providing an interacting mechanism with the user at the source language restricted to introduce information elements, phrases and sentences free of ambiguities.

It is another object of this invention to provide a flexible asymmetric system for unified coding and decoding of information that accurately represents the thoughts of a source user.

It is yet another object of this present invention to provide such a system that is inexpensive to implement and maintain while retaining its effectiveness.

Further objects of the invention will be brought out in the following part of the specification, wherein detailed description is for the purpose of fully disclosing the invention without placing limitations thereon.

### V. BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a database of indexed meaning elements each having at least one associated information element (word or symbol) and a description of each meaning element. The indexed meaning elements constitute one of the fields of the database with a finite number of meaning elements. Additional pairs of fields are assigned for each language corresponding to finite numbers of information elements such as a list of synonyms and description information.

FIG. 2 shows a database of indexed grammatical structures for each language with unique sequences for each grammatical structure. The indexed grammatical structural units are grouped in one field and each unit corresponds to others in different languages for which respective fields have been assigned.

FIG. 3 illustrates the software and method for selectively coding the information supplied by a user from the source language or decoding of a previous coded text.

FIG. 4 represents the software and method for coding the information supplied by a user from the source language as per its grammatical structure. This figure represents a detailed method of the step numbered as 308 shown in FIG. 3.

FIG. 5 is a representation of the method to be followed in decoding the information previously codified as per its grammatical structure. This figure represents a detailed method of the step numbered as 314 shown in FIG. 3.

FIG. 6 represents the method to be followed in coding phrases and clauses previously codified as per their grammatical structures. This figure represents a detailed method of the steps numbered as 413 and 415 shown in FIG. 4.

FIG. 7 shows the method to be followed in decoding previously codified phrases and clauses as per their grammatical structures. This figure represents a detailed method of the steps numbered as 514 and 516 shown in FIG. 5.

FIG. 8 illustrates the method to be followed in coding words in a previously codified text as per its grammatical structure. This figure represents a detailed method of the step numbered as 410 shown in FIG. 4.

FIG. 9 represents the method to be followed in decoding of a previous codified text as per the user's preferred lexicon for the interpretation of the meaning of a given code. This figure represents a detailed method of the step numbered as 511 shown in FIG. 5.

### VI. DETAILED DESCRIPTION OF THE PREFERRED EMBODIMENT

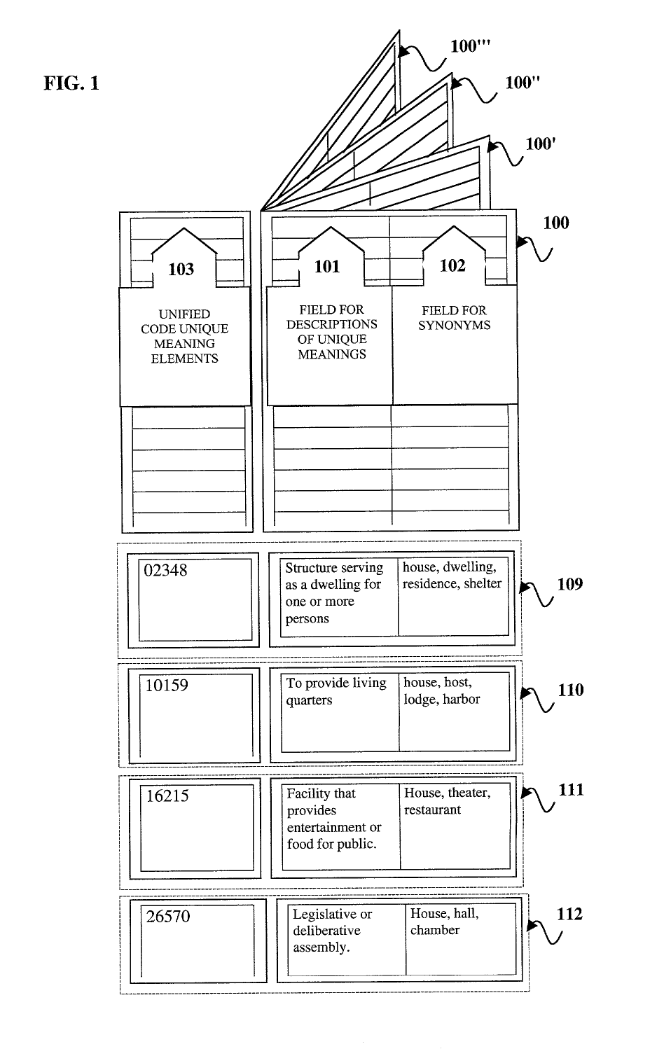

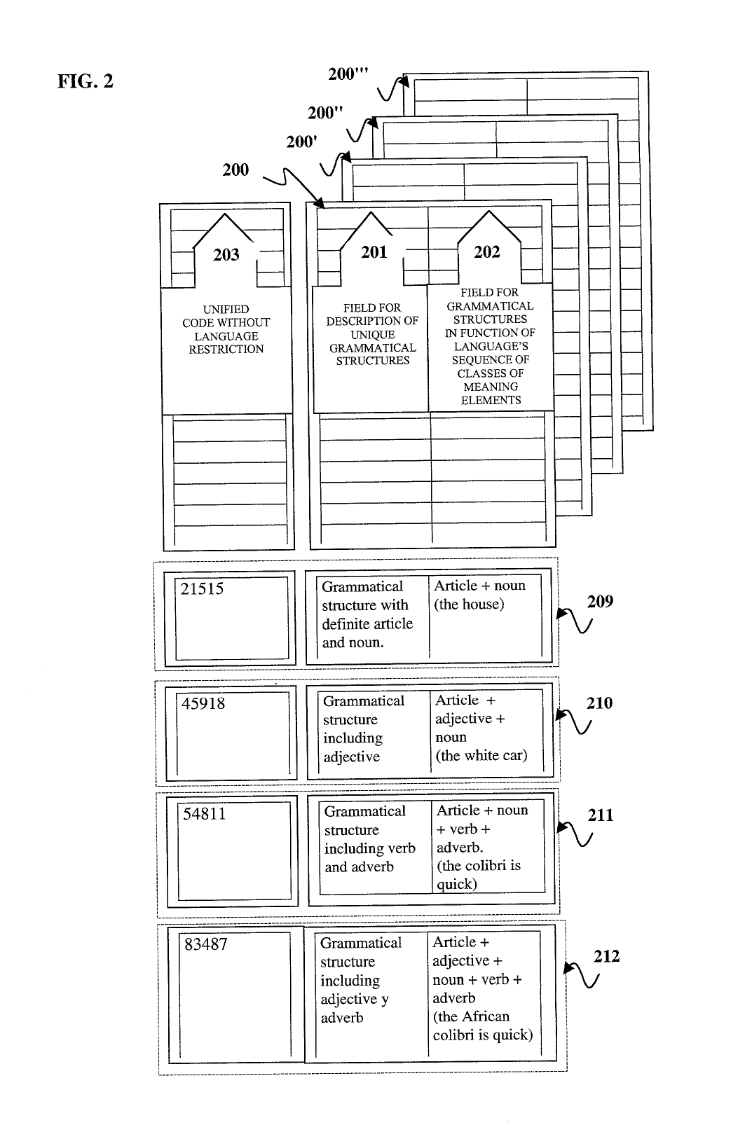

To describe the present invention, reference is made to the drawings where the boxes represent software and method steps and FIGS. 1 and 2 correspond to the tables that represent indexed meaning elements and grammatical structures, respectively. The meaning elements in FIG. 1, broadly cover any information elements such as words, symbols, pictorial, representations or anything else that has a meaning for human beings. The meaning elements, in turn are grouped in component classes, i.e. verb, adjective, etc. These classes are denoted by either an extension of the code or the location where they are stored.

FIG. 2 represents a database where a finite number of descriptions in field 201 for grammatical structures are listed in a given language recognized by humans. Field 202 corresponds to the sequences of component classes for each one of the grammatical structures or grammatical structural units described in each of the descriptions of field 201. Field 203 holds a unique code for each one of the grammatical structures. The codes in field 203 correspond to those descriptions and sequences contained in fields 201 and 202 respectively.

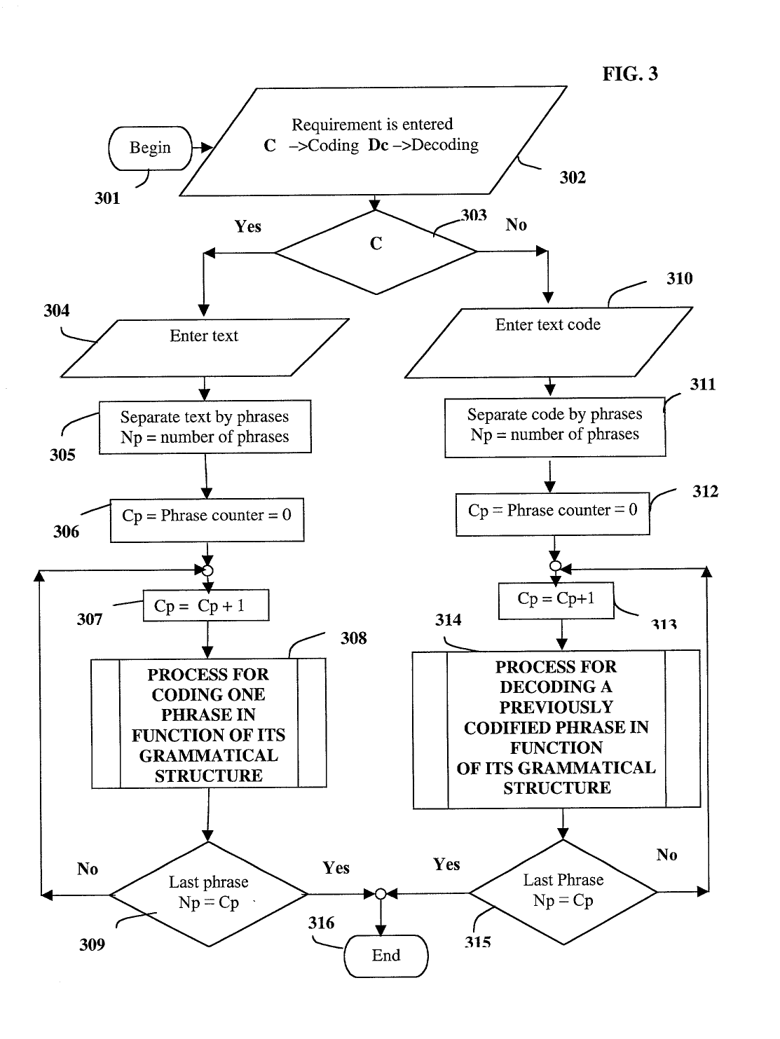

FIG. 3 corresponds to the general algorithm to be followed for selectively coding or decoding the information supplied by or to a user in his/her source language, typically through text strings entered in a computer system with the software to be described and claimed below.

We start with the concept that there is only a finite number of words and symbols in a given language. And there is also a finite number of meaning elements. In FIG. 1 we can see that the noun “house” corresponds to index No. 02348 and it relates to a structure that serves as a dwelling. Synonyms like “dwelling” and “home” provide the same information and thus correspond to the same meaning element No. 02348. A phrase or sentence that includes any one of these three words will produce the same meaning elements. If we add other languages, we can visualize them as the third dimension of levels that correspond to the same information elements and have at least one or more words or symbols, as best seen in FIG. 1. The same word “house”, however, can be used as a verb and it has different synonyms for this different meaning.

Meaning element No. 10159 corresponds to a synonym (house) in field 102 that is a verb with a different meaning. Therefore, if entered as text, the word “house” will be referenced to a different meaning element index.

In FIG. 3 the algorithm for processing text is shown. The different figures represent software programs for performing different functions, as described below. It can also be designed to accept symbols or larger pieces of information sound, entire songs, etc. To simplify, we will restrict to text words cross-referenced to meaning elements in this specification. The general algorithm represented in FIG. 3 shows how the grammatical structures are processed to be either codified or decodified. Other sub-processes are shown in the following figures and described below.

The text in a given source language is entered by a user at input assembly 301. The text is composed of at least one grammatical structure unit. Grammatical structural units can include a whole sentence or phrase or at least one clause. A grammatical structural unit may be composed of sub-units such as one or more clauses or phrases. Punctuation symbols, such as commas, periods and conjunctions are used to detect the beginnings and ends of the grammatical structural units. A user also needs to enter a command to user interface software 302 to request the coding or decoding operation. Software 303 detects the user's request and initializes the pertinent tables to initiate the operation. For the coding branch, the text is entered in software 304 and subsequently separated by software 305 into sequential grammatical structural units that could be a whole sentence, phrase or a group of classes. Software 306 ascertains the number of grammatical structural units present in the text supplied by a user and starts counting them with software 307.

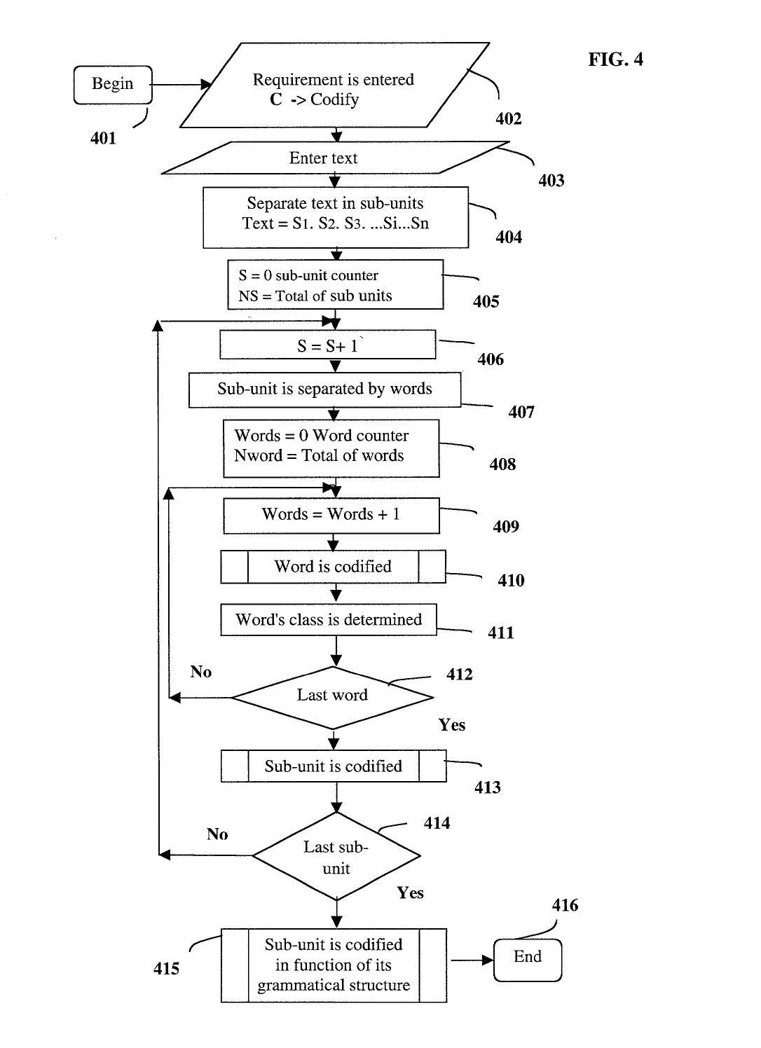

Then, the sub-process for decoding the grammatical structural units is represented as software 308, and shown in FIG. 4 in more detail. Here the grammatical structural units are codified in accordance to the table of indexed grammatical structures for the source language represented in FIG. 2. Software 309 checks for the last unit and if it is not the last unit, the process of software 309 is undertaken again with the next unit. If the last unit was processed, then the result, a sequence of codified grammatical structural units is presented to software 316 for further processing of the coded text.

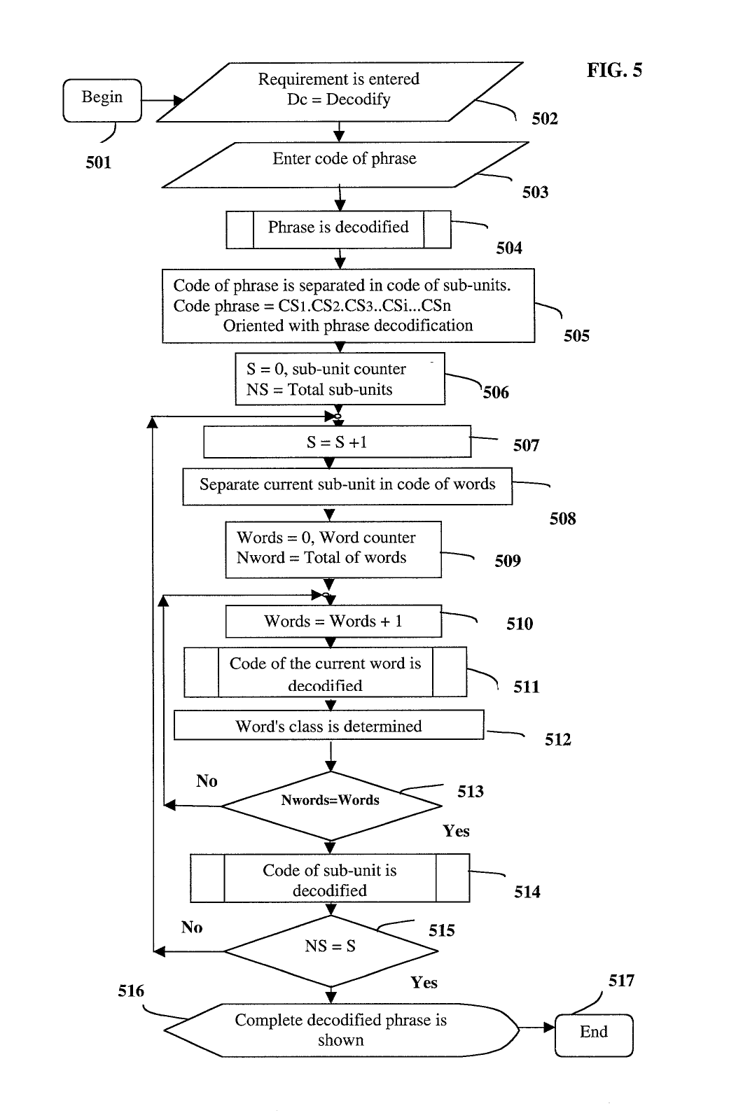

Conversely, if a codified sequence is entered at 301 and a user requests the decoding option, the sequence enters software 310 where the punctuation marks, or other markers, are identified. Then, it is processed by software 311 when the different codified grammatical structural units are separated and counted by software 312. The codified sequence and related information is then passed to counter software 310 for counting each unit being processed. Then, the codified unit is decodified by software 314 with a more detail description shown in FIG. 5, and further described below. The decoded grammatical structural units are then conveyed to software 316 for further processing through output assembly for the receiving user.

As it can be seen in FIG. 4, which corresponds to a detail representation of software 308 in FIG. 3, the method starts at 403 where the text to be codified of the first grammatical structural unit is entered. The first unit is entered as a possible sequence of phrases or clauses, unless the unit is a complete sentence. Software 404 separates the grammatical structural unit in its corresponding sub-units: phrases or clauses. Software 405 counts the number of phrases and/or clauses, if any, for the unit and set the initial counter for the sub-units to “0”. Once the text enters software 406, the sub-unit counter is advanced by one, and then software 407 separates the different grammatical structural sub-units in different meaning elements (which correspond to text words in the preferred embodiments). Software 408 counts the number of words in each sub-unit.

The decoding method is represented in FIG. 5, where block 501 represents the input assembly for entering the coded text and connected to user interface software 502 for entering the function required from the software, in this case decoding.

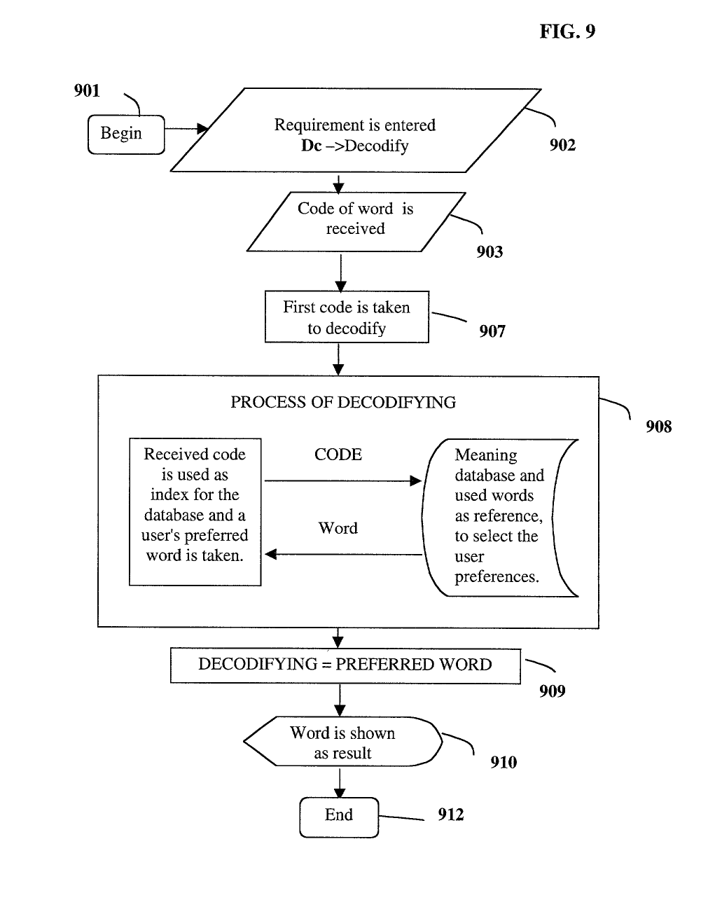

The first coded phrase to be decoded is entered in software 503 and the class of grammatical structure is decoded by software 504 thereby providing a specific sequence for the sub-units, namely, sentence, phrase(s), or clauses it is composed of. Software 505 separates the sub-units of each unit/phrase maintaining a specific arrangement dictated from the database of indexed grammatical structures. The sub-unit counter is initiated at zero and the total number of sub-units for a given grammatical structural unit is ascertained by software 506. A sub-unit counter 507 is advanced by one. The coded text of each sub-unit is then separated in individual coded words and a word counter software 509 is initiated at zero and the total number of words for the sub-unit being processed is ascertained. The word counter is advanced by one by software 510. Then, the decoding of the word being processed is undertaken by software 511, which is illustrated in more detail in FIG. 9 and described below. Block 512 represents software that extracts the class of the word (i.e. verb, adjective, etc.). In the preferred embodiment, this information can either be marked with an additional appended code to the word (or meaning element) or it can be readily ascertainable from the grouping code itself.

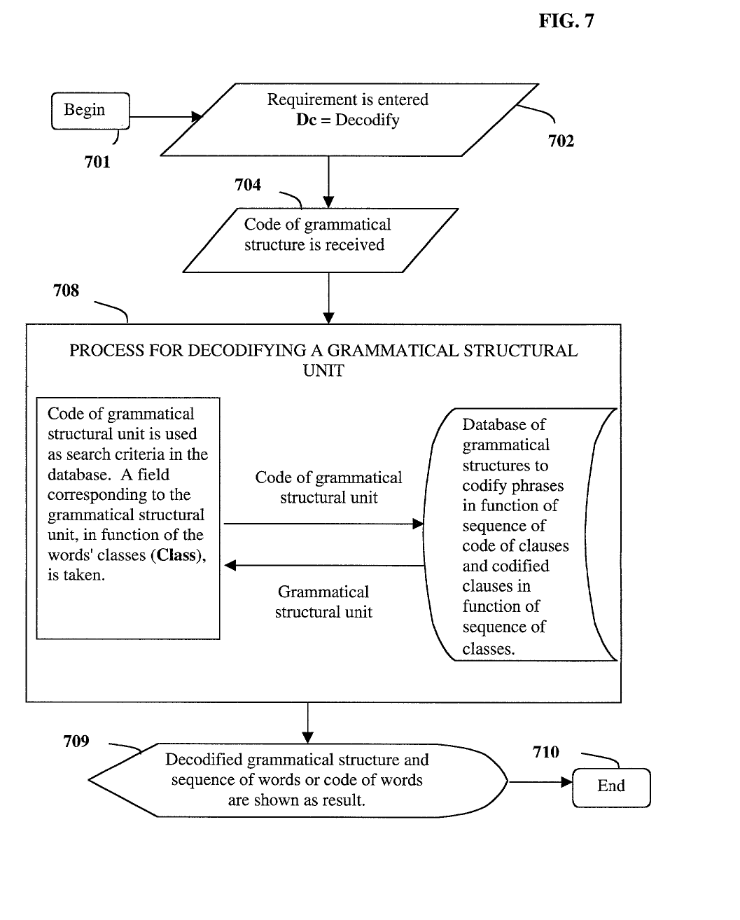

Software 513 determines whether it is the last word. If not, the next word is processed starting with software 510. If it is the last word, then the sub-unit is decoded and the sequence of decoded words is properly inserted in place by software 514, as shown in more detail in FIG. 7 and further described below. Software 515 determines whether it is the last sub-unit of the grammatical structural unit being decoded. If it is not the last sub-unit, the next sub-unit is processed starting with block 507. If it is the last sub-unit, then the result of the complete grammatical structural unit is presented to, and assembled by software 516. From there it is sent to output software 517 for further processing.

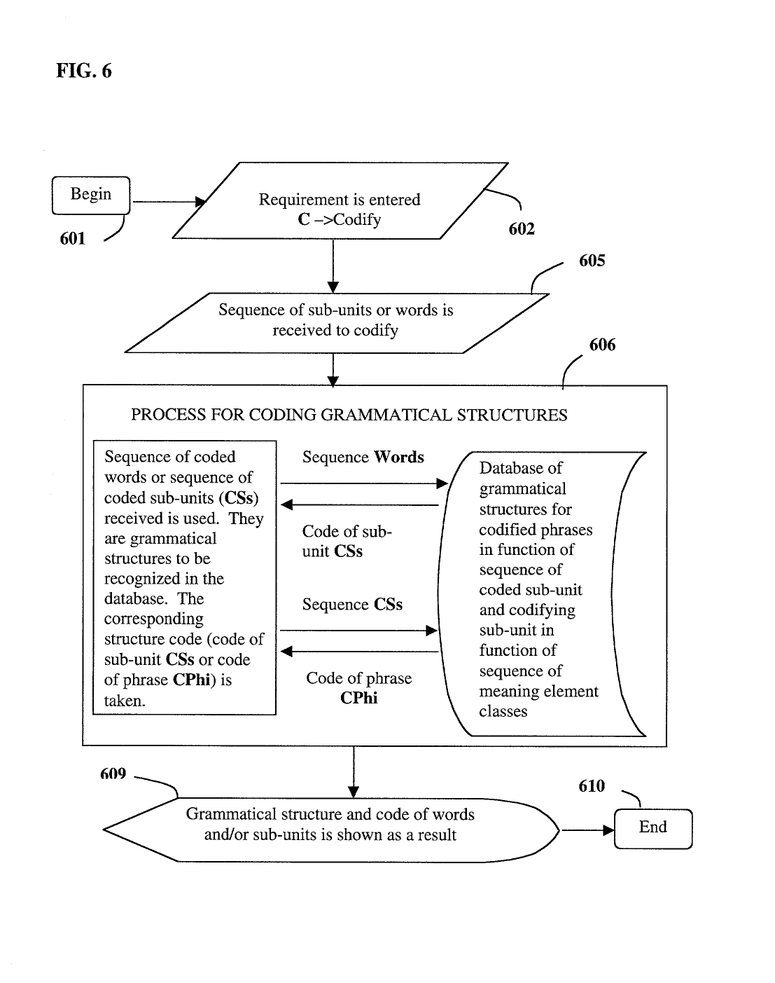

In FIG. 6, the method for coding sub-units of grammatical structural units represented in block 413 of FIG. 4 is shown. It starts with software 605 where the sequence of coded sub-units or words is received. Software 606 analyzes the sequence of the classes of meaning. From the sequence of the words, a code for a given sub-unit is obtained. From the sequence combination of sub-units, a code for units (phrases or sentences) is obtained. Then, the result is presented to software 609 for assembly and to output software 610 for further processing.

FIG. 7 shows the method flow and software algorithm for decoding the grammatical structural units represented by block 514 in FIG. 5. Software 704 receives the coded grammatical structural unit for decoding and passes it to software 708. The unit's code is compared to the indexed database for grammatical structures represented in FIG. 2 and the corresponding sequence for sub-units or language components (words) is returned. The decoded result is assembled by software 709 and processed by output software 710.

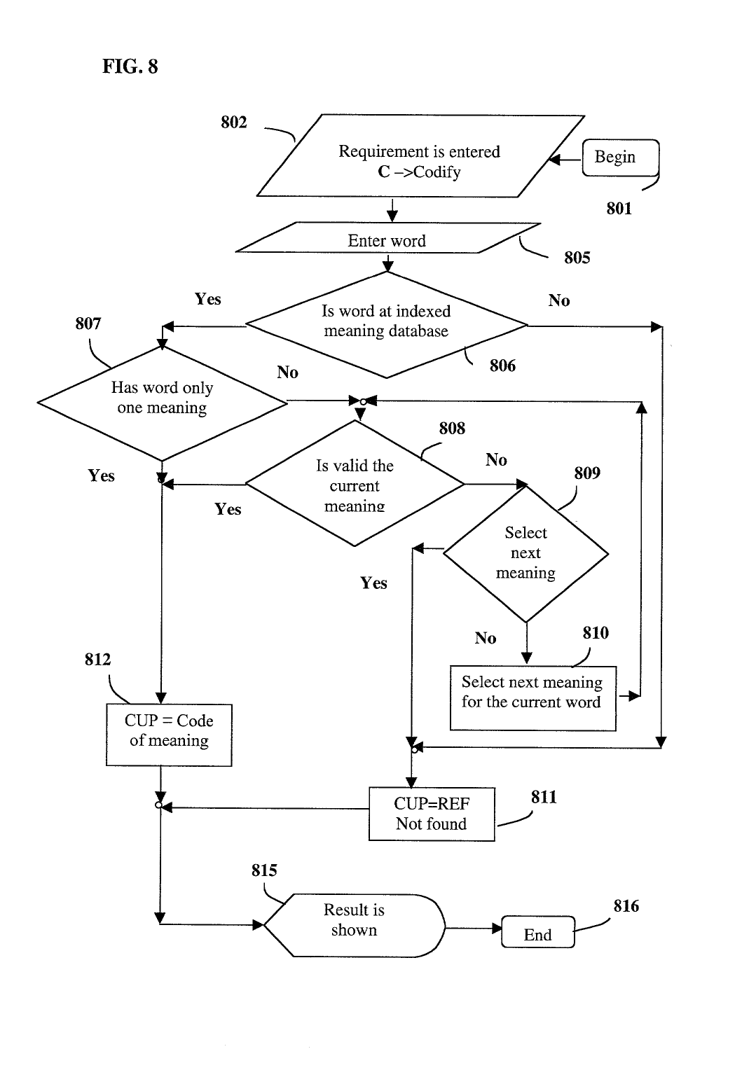

As described above, and represented as block 410 in FIG. 4, the coding method for the words is shown in FIG. 8. Software 805 receives the text word and conveys to comparison software 806, which accesses the indexed database shown in FIG. 1. Software 807 determines whether the word has a unique meaning and corresponds to one and only one meaning element. If so, the meaning element's code is selected by software 812 and forwarded to software 815 for assembly and subsequently processed by output software 816. If the word does not have only one meaning, there is an ambiguity that needs to be resolved and software 808 is activated where a user is given the opportunity to decide whether the word corresponds to a specific meaning element. If not, another meaning element is presented to the user who again has the opportunity to select this meaning element or check the next one. The user preferably identifies the meaning elements by reading from a display the synonyms in field 102 and for a description in field 101 of the meaning elements. Different manners exist for implementing this mechanism for eliminating any possible ambiguities by the source user who controls the coding. This permits that the decoding operation is free of ambiguities.

FIG. 9 represents the decoding method represented by block 511 in FIG. 5 where the coded word is received by software 903 and then forwarded to software 908 that extracts a unique meaning element from the indexed database represented in FIG. 1. A user may tailor its database for meaning elements based on his/her preferences or ethnic usage so that certain meaning elements output a particular synonym instead of other. In this manner, the preferred words are used in decoding the coded words. The decoded word is then presented to assembly software 910 and output software 912 processes it.

It should be noted also that there are languages that require two words for a particular meaning whereas in another language one word suffices. For example, in English you have to use two words to say “stopped raining” and in Spanish you merely say “escampó”. Similarly, in English there is a word for “injunction” and in Spanish more than one word is required “orden de prohibición”. But, it is clear that only one meaning is represented by an information element.

### VII. INDUSTRIAL APPLICABILITY

It is apparent from the previous paragraphs that an improvement of the type for such a computerized system and method for coding and decoding words and symbols are quite desirable for translating accurately from one language to one or more other languages without ambiguities. Also, the coding results in a more efficient way of storing information with minimum storage usage and/or bandwidth requirements for subsequent reconstitution, even if not translated to a different language.

What is claimed is:

1. A computerized system for coding words and symbols, comprising:
A) computer means having associated storage means;
B) a first indexed database having a first field containing codes for a plurality of unique meaning elements and a second field of words or symbols that correspond in meaning to each of said unique meaning element, further including means for classifying said meaning elements in one of a predetermined number of classes, said first indexed database residing in said storage means;
C) input means for entering words and symbols in said computer means;
D) coding software means for selecting one of said meaning elements for each of the words or symbols entered through said input means including means for determining whether the word or symbol entered validates a unique meaning element and if said word or symbol does have only one meaning element, producing a resulting code, and further including means for displaying a selection of meaning elements if said word or symbol entered validates more than one meaning element, and further including means for detecting one meaning element by a user from said displayed selection of validated meaning elements for producing a resulting meaning code; and
E) output means for storing said resulting meaning code.

2. The computerized system set forth in claim 1, wherein said first indexed database includes a plurality of second fields, each second field is associated with one language having at least one word or symbol that corresponds in meaning to each of said meaning elements.

3. The computerized system set forth in claim 2 further including:
F) a second indexed database having a third field containing codes for a plurality of grammatical structural units and a plurality of fourth fields, each fourth field including a predetermined number of grammatical structural units in a language, each of said grammatical structural units in each of said fourth field being correlated with only one of second grammatical structural units in the other fourth fields, said grammatical structural units being classified in accordance with the sequences of the classes of said meaning elements present in each of said grammatical structural units;
G) means for identifying sequences of the classes of said resulting meaning codes and correlating said sequences of classes implicit in said meaning codes with one of said grammatical structural units and producing a resulting grammatical structural code; and
H) output means for storing said resulting grammatical structural code.

4. The computerized system set forth in claim 1, further including:
I) decoding software means for selecting one of said resulting meaning codes and cross-referencing each of said resulting meaning codes to a unique word or symbol; and
J) output means for storing said words or symbols.

5. The computerized system set forth in claim 4, wherein said first indexed database includes a plurality of second fields, each second field is associated with one language having at least one word or symbol that corresponds in meaning to each of said meaning elements.

6. The computerized system set forth in claim 5 further including:
F) a second indexed database having a plurality of third fields, each third field including a predetermined number of grammatical structural units in a language, each of said grammatical structural units in a third field being correlated with only one of said grammatical structural units in the other third fields, said grammatical structural units being classified in accordance with the sequences of the classes of said meaning elements present in each of said grammatical structural units;
G) means for identifying sequences of the classes of said resulting meaning codes and correlating said sequences of classes implicit in said meaning codes with one of said grammatical structural units and producing a resulting grammatical structural code; and
I) output means for storing said resulting grammatical structural code.
K) means for identifying said resulting grammatical structural unit codes with a unique sequence of classes of resulting meaning elements;
L) means for assembling said unique words or symbols in one of said unique sequences of classes of resulting meaning elements; and
M) output means for storing said sequences of unique words or symbols.

7. A method for coding word and symbols, comprising the steps of:
A) arranging a plurality of unique meaning elements in a first field of a first indexed database;
B) arranging a corresponding plurality of words or symbols in a second field of said first indexed database;
C) grouping said meaning elements in one of a plurality of classes;
D) entering words or symbols in a computerized system selecting a meaning element for each of said word or symbol entered;
E) determining whether each of said words or symbols validate a unique meaning element;
F) determining all unique meaning element for words or symbols entered having more than one unique meaning element and validating one of said unique meaning element;
G) selecting a unique meaning element for validated words or symbols producing a resulting code; and
H) storing said resulting meaning code.

8. The method set forth in claim 7, further including the steps of:
I) arranging a predetermined numbers of second fields, one second field for each language, and each second field having at least one word or symbol that corresponds in meaning to each of said meaning elements.

9. The method set forth in claim 7, further including the steps of:
J) arranging a plurality of grammatical structural units in each of a predetermined number of third fields in a second indexed database and of said grammatical structural unit characterized by having a unique sequence of classes of meaning elements, each third field associated with a different language, and each of said grammatical structural units in each of said third fields referenced to other units in other third field and commonly identified with a grammatical structural unit code.
K) identifying sequences of classes of said resulting meaning codes and correlating said sequences with one of said grammatical structural units a said third fields; and
L) storing said resulting grammatical code.

10. The method set forth in claim 7, further including the steps of:
M) entering said resulting codes in a computerized system;
N) selecting each of said resulting codes and cross-referencing them to a unique word or symbol; and
O) storing said words or symbols.

11. The method set forth in claim 10, further including the steps of:
P) arranging a predetermined number of second fields, one second field for each language, and each second field having at least one word or symbol that corresponds in meaning to each of said meaning elements.

12. The method set forth in claim 11, further including the steps of:
J) arranging a plurality of grammatical structural units in each of a predetermined number of third fields in a second indexed database and of said grammatical structural unit characterized by having a unique sequence of classes of meaning elements, each third field associated with a different language, and each of said grammatical structural units in each of said third fields referenced to other units in other third field and commonly identified with a grammatical structural unit code.
K) identifying sequences of classes of said resulting meaning codes and correlating said sequences with one of said grammatical structural units a said third fields;
L) storing said resulting grammatical code;
Q) identifying said resulting grammatical structural unit codes with a unique sequence of classes of resulting meaning elements;
R) assembling said unique words or symbols in one of said unique sequences of classes of resulting meaning elements; and
S) storing said sequences of unique words or symbols.
